(19) United States
(12) Patent Application Publication
(10) Pub. No.: US 2023/0173736 A1
(43) Pub. Date: Jun. 8, 2023

(54) APPARATUS FOR DETACHING FOLDABLE INNER BAGS FROM THE INNER WALLS OF RIGID OUTER CONTAINERS

(71) Applicant: Gaplast GmbH, Altenau (DE)

(72) Inventors: Stephan Kneer, Farchant (DE); Kasim Yilginc, Oberammergau (DE)

(21) Appl. No.: 18/052,198

(22) Filed: Nov. 2, 2022

(30) Foreign Application Priority Data
Dec. 8, 2021 (DE) 10 2021 132 329.0

(51) Int. Cl. B29C 49/42; B29C 49/04

(52) U.S. Cl. CPC B29C 49/42101; B29C 49/04; B29L 2031/712

(57) ABSTRACT

An apparatus including a conveyor track for upright containers, which is constituted by a horizontal, rotating conveyor belt, a vertical conveyor belt rotating in the same direction, which is arranged on one side of the horizontal conveyor belt and a vertical, fixed belt on the opposite side of the horizontal conveyor belt, where a distance between the vertical conveyor belt and the fixed belt is smaller than an outer diameter of the upright containers so that the upright containers rotate about a vertical axis as the upright containers pass between the rotating, vertical conveyor belt and the fixed, vertical belt and are laterally compressed so that the inner bags detach abruptly from the outer containers.

### PRIORITY CLAIM

The subject application claims convention priority to German patent application No. DE 10 2021 132 329.0, filed Dec. 8, 2021.

### BACKGROUND

The inner bags and the outer containers of containers of the type under consideration do not form a weld connection with one another but they stick to one another when they are produced in an extrusion method. Before such a container is capable of being used, i.e. of being filled with a liquid or, for instance, pasty container filling, which is then gradually dispensed by means of an Airless pump or by compressing the container, the inner bag must be detached from the wall of the outer container and then applied to it again. For this purpose, an apparatus is known which applies a reduced pressure through the container opening to the inner bag, which thereupon suddenly collapses. The apparatus subsequently conducts compressed air again into the inner bag in order to apply it again to the outer container so that it can be completely filled with the container filling. If the inner bag is not uniformly detached from the wall of the outer container, a relatively large subatmospheric pressure occurs in the inner bag, when the filling material is dispensed, despite pressure balancing openings in the wall of the outer container, whereby the functional capability of a pump, which is generally provided, can be impaired.

DE 10 2006 012 487 A1 discloses an improved detaching apparatus, which bores through the outer container and subsequently introduces a pressure medium into the gap between the outer container and the inner bag, after the apparatus has sealed the container opening, whereby the introduction of the pressure medium into the gap is stopped when a predetermined pressure threshold value has been reached and whereby, after the pressure has been released by the apparatus, a pressure medium is introduced into the inner bag in order to apply it again to the container wall.

This apparatus for detaching the inner bag from the inner wall of the outer container has a complex construction and considerably increases the manufacturing time of usable containers of the type under consideration.

### SUMMARY

It is the object of the present invention to provide a simply constructed apparatus for detaching foldable inner bags from the inner walls of associated rigid outer containers, with which this process may be performed very much more rapidly.

The apparatus in accordance with the invention includes a conveyor track for upright containers, which is constituted by a horizontal, rotating conveyor belt, wherein the conveyor track is bounded by a vertical conveyor belt, which rotates in the same direction and is arranged on one side of the horizontal conveyor belt and, on the opposite side, by a vertical, fixed belt, wherein the distance between the vertical conveyor belt and the fixed belt is somewhat smaller than the outer diameter of the containers so that, when passing between the vertical, rotating conveyor belt and the fixed vertical belt, the containers rotate about their vertical axis and are laterally compressed, whereby the inner bags detach abruptly from the outer containers. The pressure balance then occurs in the gap between the inner bag and the outer container through the partially open pinch seam on the base of the outer container. The inner bags automatically engage the outer containers again by virtue of their elasticity without new adhesive forces occurring thereafter.

The apparatus in accordance with the invention has a simple structure and operates with very short cycle times.

It is proposed with advantage that the distance between the vertical, rotating conveyor belt and the vertical, fixed belt is adjustable, whereby the position of the fixed belt is conveniently adjustable. The height of the two belts is preferably also adjustable.

In accordance with a further proposal of the invention, the vertical conveyor belt is provided with its own drive device.

The two conveyor belts conveniently consist of fabric or rubber whilst the fixed vertical belt can consist of an aluminium alloy or of steel. Higher frictional forces prevail between the two conveyor belts and the containers passing between them than with the fixed vertical belt so that the containers are transported uniformly with the conveying speed of the horizontal, rotating conveyor belt and are rotated at the rotating, vertical conveyor belt about their longitudinal axis.

The dimensions of the conveyor belts and their running speed are so set that the containers rotate at least once through 360° against the vertical, rotating conveyor belt by the time they exit from the conveyor belts. The inner bags are thereby detached from the inner walls of the rigid outer containers over their entire periphery.

The horizontal conveyor belt is preferably arranged close to the blow mould of the coextrusion machine where a gripper removes the blown containers from the blow mould and positions them on the horizontal conveyor belt. The apparatus in accordance with the invention is thus a component of a coextrusion-blowing installation. The finished containers are received at the end of the horizontal conveyor belt in a collecting container.

The inner bags of the containers manufactured in a coextrusion process can consist of at least two layers, wherein the layer directed towards the outer containers consists of a mixture of EVOH and a plastic material with elastic properties. The inner bags thereby gain a considerable stiffness, although they are completely foldable when dispensing the contents of the containers, which is due to the plastic material component with elastic properties. Surlyn is proposed for the elastic material, which is present in the dispersed phase in the EVOH. 85 EVOH 15 SY, for instance, is proposed for the outer layer of the inner bag. Surlyn, for instance, is suitable for the inner layer which contacts the product.

### BRIEF DESCRIPTION OF THE DRAWINGS

Further details of the invention will be apparent from the following description of one preferred embodiment of the invention and with the aid of the drawings, in which:

FIG. 1 is a side view of one embodiment of the apparatus in accordance with the invention;

FIG. 2 is a plan view of the apparatus of FIG. 1;

FIG. 3 is a front view of the apparatus.

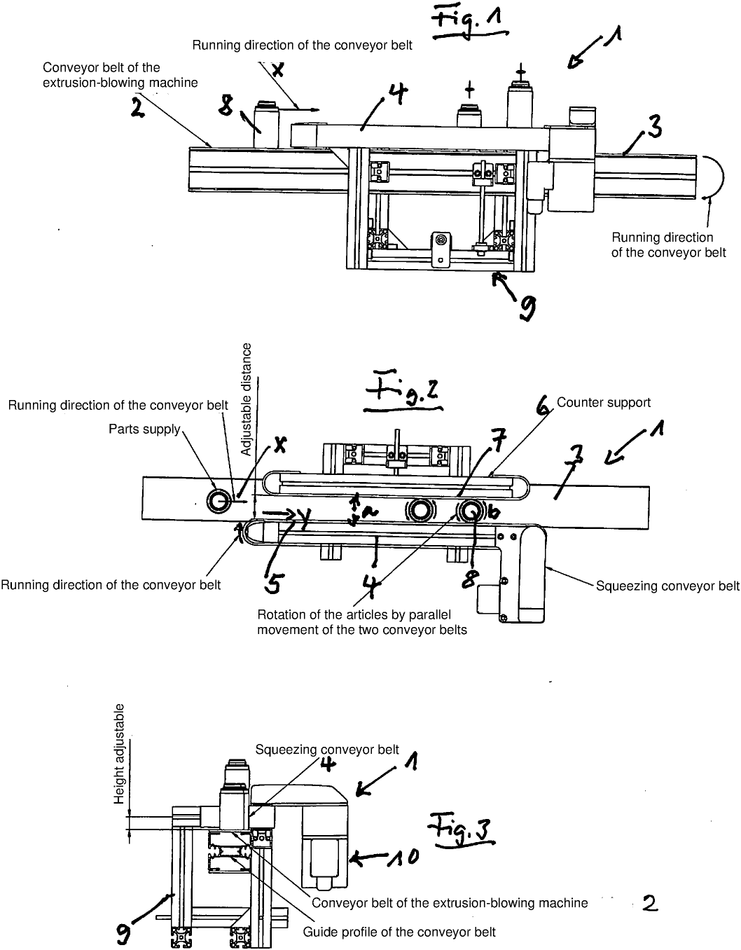

### DETAILED DESCRIPTION

The apparatus, provided in the figures generally with the reference numeral 1, includes a horizontal, rotating conveyor belt 2, which is arranged in the vicinity of a blow mould, which is not shown, of a coextrusion blowing machine. Arranged on one longitudinal side of the horizontal conveyor belt 2, above its upper run 3, is a vertical, rotating conveyor belt, referred to below as a squeezing conveyor belt 4. The inner run 5 of the squeezing conveyor belt 4 runs with the same speed as the upper run 3 of the horizontal conveyor belt 2. The direction of movement of the horizontal conveyor belt is designated in the figures with X whilst the direction of movement in the same direction of the inner run 5 of the squeezing conveyor belt 4 is identified with Y.

Arranged above the opposing longitudinal side of the upper run 3 of the horizontal belt conveyor 2 is a fixed, vertical belt 6, which constitutes a counter support and which consists of a smooth material, such as aluminium alloy or steel. The two rotating conveyor belts 2 and 4 consist of fabric or of a rubber alloy.

The inner run 5 of the squeezing conveyor belt 4 extends parallel to the inner run 7 of the fixed belt 6, whereby the spacing a from one another is somewhat smaller than the outer diameter of the containers 8 to be handled. When passing between the squeezing conveyor belt 4 and the fixed belt 6 the containers 8 rotate completely in the direction of the arrows b at least once about their vertical axis, whereby the inner bags of the containers 8 abruptly come free form the outer containers, which is also perceptible acoustically.

The entire apparatus 1 is fastened on a frame 9, for the structural details of which reference is made to the figures. The squeezing conveyor belt 4 is provided with its own motor 10, which drives the squeezing conveyor belt 4 with the same running speed as that with which the horizontal conveyor belt rotates.

1. An apparatus for detaching foldable inner bags from inner walls of associated rigid outer containers of containers, which are manufactured in a coextrusion process, wherein the inner bags have a considerable stiffness and a rough surface with microscopically small protuberances and recesses and thereby adhere to the outer containers only with low adhesive forces without being welded to the outer containers, and wherein the outer containers have an at least partially open pinch seam at their base, in which a welded base seam of the inner bags is held, the apparatus comprising:
a conveyor track for upright containers, which is constituted by a horizontal, rotating conveyor belt, a vertical conveyor belt rotating in the same direction, which is arranged on one side of the horizontal conveyor belt (2), and a vertical, fixed belt (6)-on the opposite side of the horizontal conveyor belt, wherein a distance between the vertical conveyor belt (4)-and the fixed belt is smaller than an outer diameter of the upright containers so that the upright containers rotate about a vertical axis when the upright containers pass between the rotating vertical conveyor belt and the fixed vertical belt and are laterally compressed so that the inner bags abruptly separate from the outer containers.

2. The apparatus as claimed in claim 1, wherin the distance between the vertical, rotating conveyor belt and the vertical, fixed belt is adjustable.

3. The apparatus as claimed in claim 1, wherein the vertical conveyor belt runs at the same speed as the horizontal conveyor belt.

4. The apparatus as claimed in claim 1, further comprising an individual drive device provided for the vertical, rotating conveyor belt-(4).

5. The apparatus as claimed in claim 1, wherein the rotating conveyor belt and the vertical conveyor belt consist of fabric or rubber.

6. The apparatus as claimed in claim 1, wherein the fixed, vertical belt consists of an aluminium alloy or steel.

7. The apparatus as claimed in claim 1, wherein the rotating conveyor belt and the vertical conveyor belt run at such a speed that the upright containers rotate at least once through 360° against the vertical conveyor belt.

8. The apparatus as claimed in claim 1, wherein the horizontal, rotating conveyor belt is arranged close to or below the blow mould of an associated coextrusion blowing machine.
